(19) United States
(12) Patent Application Publication
(10) Pub. No.: US 2009/0159554 A1
(43) Pub. Date: Jun. 25, 2009

(54) Container Closure

(75) Inventor: Bradley McCardell, Rochester, MI (US)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: INNATECH, LLC, Rochester, MI (US)

(21) Appl. No.: 12/341,639

(22) Filed: Dec. 22, 2008

Related U.S. Application Data
(60) Provisional application No. 61/008,984, filed on Dec. 21, 2007.

(51) Int. Cl. B65D 51/16; B65D 51/00; B29C 45/14

(52) U.S. Cl. 215/310; 215/316; 264/242

(57) ABSTRACT

A closure is provided having a base formed of a first material and cap formed of a second material. The first material and the second material are chemically incompatible with one another such that the base and the cap do not bond together when formed using a sequential injection molding process. The cap is movable upon the base between a closed and open configuration. The closure forms a seal impervious to liquids when the cap is in the closed configuration. Alternatively, in the open configuration, the closure is suitable to dispense a product.

### CROSS REFERENCE TO RELATED APPLICATION

This application claims priority from U.S. Provisional Application No. 61/008,984 filed on Dec. 21, 2007.

### TECHNICAL FIELD

The present invention relates generally to closures, and particularly to container closures.

### BACKGROUND

Caps and closures are often utilized to seal containers of liquid, semi-liquid, granular, and solid products. Often, these closures are one-piece cup-shaped caps having screw threads on an inner surface that mate with corresponding screw threads on the exterior of a container neck. In order to dispense a product within the container, the closure must be rotated and removed from the container. Accordingly, the cap may become misplaced or damaged while it is removed from the container; therefore, some users may prefer a closure that does not have to be removed from the container in order to dispense a product.

Closures capable of dispensing a product without being removed from a container are known in the art; however, these types of closures often do not adequately seal the container opening. Specifically, when the container is used to store a liquid product, the product may leak from the closure, even when the closure is in a closed configuration. Furthermore, many of these closures are permanently fixed to the container opening, thereby preventing a user from refilling the container or dispensing the contents of the container directly from the container opening. In addition, closures capable of adequately sealing a container opening and dispensing a product without being removed from the container are often difficult to manufacture and assemble. As a result, known closures of this type are often expensive to produce.

In view of the foregoing, it would be advantageous to provide a closure capable of dispensing a liquid, semi-liquid, solid, granular, or powdered product without being removed from the container. It would also be advantageous to provide a closure, which forms a seal impervious to liquid, semi-liquid, solid, and granular or powdered products. In addition, it would be advantageous if the closure could be removed from the container to refill the container or to allow a user to dispense a product directly from the container. Furthermore, it would be advantageous if the closure was inexpensive and simple to manufacture.

### SUMMARY

A new closure comprises a base made of a first material and a cap made of second material. The base includes a connecting structure to secure the closure to a container. The cap is secured to the base and may be rotatable between an open and a closed configuration. In the open configuration, an opening in the cap is aligned with an opening in the base, permitting a product stored within the container to pass through the closure. In the closed configuration, a solid region of the cap completely covers the opening in the base, forming a seal between the base and cap that is impervious to the flow of liquid, semi-liquid, solid, granular, and powered products.

The new closure may be inexpensively formed with a two-shot sequential injection molding process. Specifically, a first polymer is used to form the base, and a second polymer is used to form the cap. The two polymers are selected such that they are chemically incompatible and do not bond together during or after the molding process. Therefore, the cap material can be injected as a molten polymer around the base without the cap material bonding to the base, thereby allowing the cap to rotate about the base following the molding process. Furthermore, following the molding process, the second material may decrease in size as the polymer cools, creating a zero-clearance fit between the base and the cap.

The above described features and advantages, as well as others, will become more readily apparent to those of ordinary skill in the art by reference to the following detailed description and accompanying drawings. While it would be desirable to provide a container closure, which provides one or more of these or other advantageous features as may be apparent to those reviewing this disclosure, the teachings disclosed herein extend to those embodiments, which fall within the scope of the appended claims, regardless of whether they accomplish one or more of the above-mentioned advantages or include all of the above-mentioned features.

### BRIEF DESCRIPTION OF THE DRAWINGS

FIG. 1 depicts a perspective view of a container closure with a cap of the closure in an open position.

FIG. 2 depicts a perspective view of the closure of FIG. 1 with the cap of the closure in a closed position.

FIG. 3 depicts a perspective view of a base of the closure of FIG. 1.

FIG. 4 depicts a cross sectional view of the base of the closure of FIG. 3.

FIG. 5 depicts a perspective view of the cap of the closure of FIG. 1

FIG. 6 depicts a cross sectional view of the closure of FIG. 1.

FIG. 7 depicts a flowchart illustrative of a process for forming the closure of FIG. 1.

FIG. 8 depicts a perspective view of the first stage of the molding process for molding the closure of FIG. 1.

FIG. 9 depicts a perspective view of the second stage of the molding process for molding the closure of FIG. 1.

FIG. 10 depicts an orthographic view of the second stage of the molding process for molding the closure of FIG. 1.

FIG. 11 depicts a perspective view of the third stage of the molding process for molding the closure of FIG. 1.

FIG. 12 depicts an orthographic view of the third stage of the molding process for molding the closure of FIG. 1.

FIG. 13 depicts a perspective view of another embodiment of the container closure.

FIG. 14 depicts a perspective view of another embodiment of the container closure.

### DETAILED DESCRIPTION

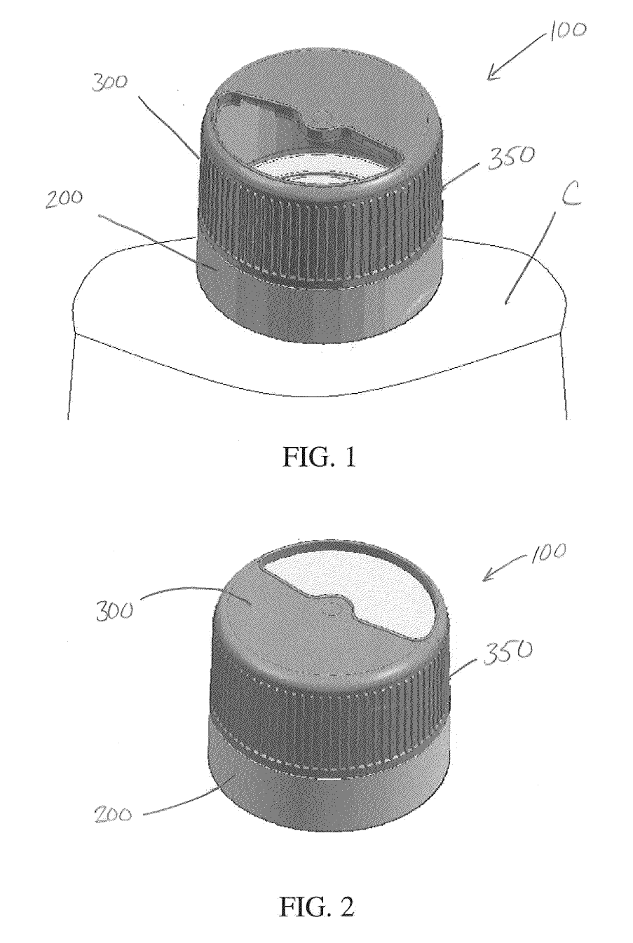

As illustrated in FIG. 1, a container closure 100 includes a base 200 made of a first material and a cap 300 made of a second material, with the cap fitting over the base. The base 200 is a cup-shaped member configured for connection to a container C. The cap 300 is a cup-shaped member configured for connection to the base 200. The cap 300 rotates between an open position (FIG. 1), which permits a product to be dispensed from a container C, and a closed position (FIG. 2), which seals a container C. Below, each element of the closure 100 and a process 700 for manufacturing the closure are described in detail.

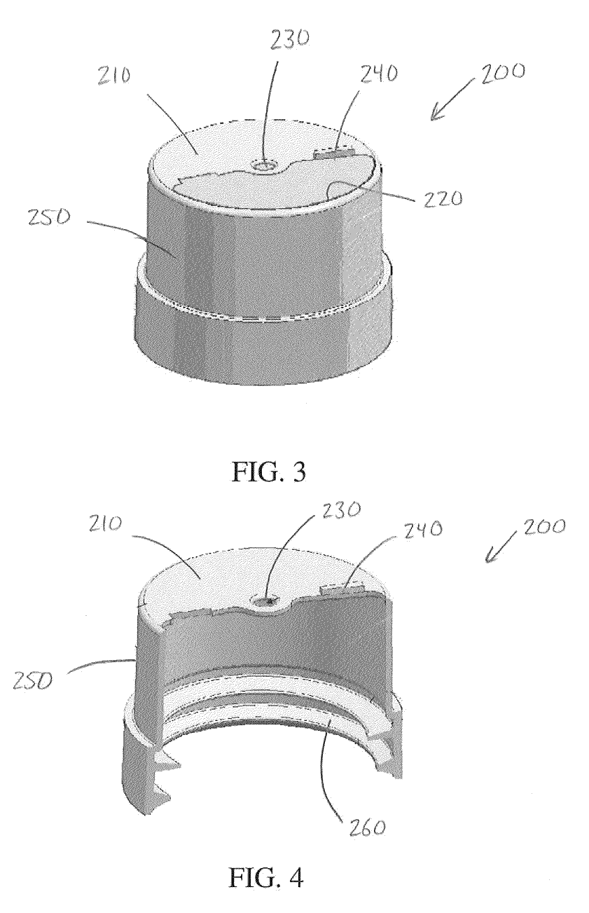

Referring now to FIG. 3, the base 200 includes a disk region 210 having a base opening 220, a rotational aperture 230, and a stop detent 240. Furthermore, the base 200 includes a cylindrical sidewall region 250 having a connecting structure 260, as illustrated in FIG. 4. The disk region 210 provides a substantially flat upper surface/face for the cup-shaped base 200. Alternatively, the disk region 210 may also be domed slightly to increase the structural integrity of the closure 100 during use. The base opening 220 is an opening through the disk region 210 configured to allow a product to pass therethrough. In the illustrated embodiment, the base opening 220 has a radial dimension, which extends substantially from the center of the disk region 210 to substantially the sidewall region 250. The base opening 220 has a second dimension, which encompasses approximately 160° to 180° of the disk region 210. In another embodiment, the radial dimension of the base opening 220 may extend from an intermediary point along the radius of the disk region 210 to substantially the sidewall region 250. Likewise, the base 200 may include a plurality of base openings 220 having second dimensions, which total 5° to 180°.

The connecting structure 260 of the base 200, as illustrated in FIG. 4, is configured to engage the opening of a container C. The nature and dimensions of the connecting structure 260 can be tailored to the specific type of container C to be sealed. For example, as illustrated in FIG. 4, the connecting structure 260 includes screw threads configured to engage a corresponding set of screw threads on the exterior of a container C. In other embodiments, the connecting structure 260 may include an inner collar (not illustrated) designed to be forcibly pressed over a corresponding collar on a container C. In still further embodiments, the connecting structure 260 need not have a circular periphery. Instead, the connecting structure 260 can be configured to match the dimensions of a container C having a square, rectangular, or ellipsoidal opening. However, the portion of the base 200 in contact with the cap 300 should maintain a generally circular periphery to enable the cap 300 to rotate about the base 200.

The rotational aperture 230, illustrated in FIGS. 3 and 4, is an opening in the disk region 210 that is sized to accept a protrusion 360 extending from the cap 300. The rotational aperture 230 is generally in the center of the disk region 210 to permit the cap 300 to rotate about the base 200 evenly and smoothly.

Referring still to FIGS. 3 and 4, the stop detent 240 protrudes from the disk region 210 and serves to secure the cap 300 in the open and closed configurations. In one embodiment, the stop detent 240 is located at the edge of the base opening 220. The length of the stop detent 240 may be measured radially from the rotational aperture 230. Suitable stop detent 240 lengths may range from approximately one-eighth to three-fourths of the disk region 210 radius. Furthermore, the stop detent 240 has a height determined by the distance the stop detent 240 protrudes from the base 200. An exemplary stop detent 240 height may be approximately one to three millimeters. The dimensions of the stop detent 240 determine the magnitude of force required to secure the cap 300 in the open and closed configurations. Specifically, a long and/or high stop detent 240 secures the cap 300 more rigidly than a short and/or low stop detent 240. Finally, it should be noted that embodiments of the closure 100 without a stop detent 240 seal containers C sufficient well; however, these embodiments do not secure the cap 300 in the open or closed positions.

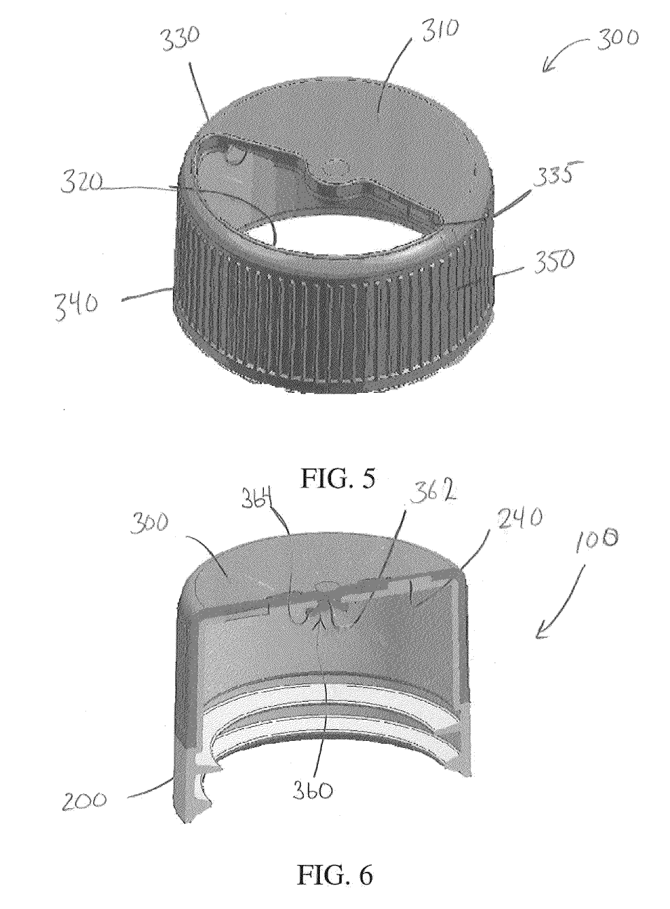

As illustrated in FIG. 5, the cap 300 includes a disk region 310, a cap opening 320, one or more detent grooves 330, 335, and a sidewall region 340 having a plurality of gripping ribs 350. Furthermore, the cap 300 includes a rotational protrusion 360, as illustrated in FIG. 6. The cap 300 disk region 310 is the substantially flat upper surface/face of the cup-shaped cap 300. The cap opening 320 is an opening through the disk region 310 configured to allow a product to pass therethrough. The dimensions of the cap opening 320 may be identical to the base opening 220, such that when the cap 300 is rotated to the open configuration, the cap opening 320 and the base opening 220 become aligned. Closure 100 embodiments having multiple base openings 220 may have a cap opening 320 corresponding to each base opening 220.

The rotational protrusion 360 couples the cap 300 to the base 200. As illustrated in FIG. 6, the protrusion 360 includes a post 362 that extends through the rotational aperture 230, and is configured to rotate within the rotational aperture 230. The wide terminal portion 364 of the protrusion 360 is attached to the end of the post 362 and prevents the protrusion 360 from being removed from the aperture 230, thereby securing the cap 300 to the base 200. Note that other embodiments of the closure 100 may include a protrusion 360 removably secured to the aperture 230, such that the cap 300 may be removed from the base 200. A removable cap 300 may facilitate cleaning of the closure 100 or permit a user to select a cap 300 having a cap opening or openings 320, which are particularly suited to the product being dispensed.

A pair of detent grooves 330, 335 are formed in the side of the cap 300 nearest the base 200. The detent grooves 330, 335 are depressions in the disk region 310 having a size and shape approximately equal to the stop detents 240. As illustrated in FIG. 5, detent groove 335 has been positioned directly above the stop detent 240. In this position, the stop detent 240 fills the detent groove 335, and secures the cap 300 in the open configuration. When the closure 100 is in the closed configuration, detent groove 330 may be positioned directly above the stop detent 240, thereby securing the cap 300 in the closed configuration.

The sidewall region 340 of the cap 300 includes a surface texture, having a plurality of ribs 350, suitable for gripping. The gripping ribs 350, as illustrated in FIGS. 1, 2, and 5, are a plurality of vertical ridges and grooves, which increase the coefficient of friction between the sidewall region 340 and the hand or glove of a user. The gripping ribs 350 simplify rotation of the cap 300, even if the cap 300 where to become wet or otherwise slippery. The closure 100 may include other types of surface textures suitable for gripping, include one or more tabs (not illustrated), which extend radially from the sidewall region 340.

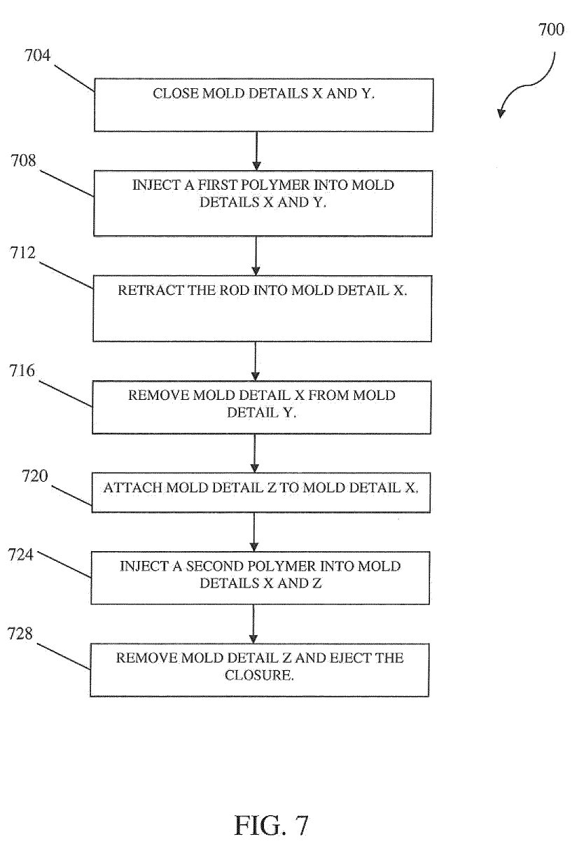

The closure 100 may be manufactured using a multi-shot sequential injection molding (“SIM”) process 700 as illustrated in the flowchart of FIG. 7. Sequential injection molding enables manufacturers to inject at least two types of molten polymers or resins into a die, mold, or a mold having multiple sections referred to as mold details. The injected polymers may have similar characteristics or may be quite different. For example, depending on the characteristics of the polymers, the molten polymers may bond together during the injection process. Alternatively, the polymers may remain separate both during and after the molding process, even though the molten polymers may have contacted each other during the molding process. Finally, one or more of the polymers may change size as it cools. An exemplary SIM process 700 for molding the closure 100 is presented below, beginning with a description of suitable polymer materials.

In the present invention, two polymers are utilized to mold the closure 100. A first polymer is used to mold the base 200, and a second polymer is used to mold the cap 300. The first and second polymers are chemically incompatible and do not bond together during or after the molding process 700. Additionally, injection of the second polymer does not impact the shape of the component or components molded with the first polymer. Suitable first polymers for molding the base 200 include, but are not limited to polyethylene, polypropylene, polyesters, bioresins, and other thermoplastic elastomers. Suitable second polymers for molding the cap 300 include, but are not limited to polyethylene, polypropylene, polyesters, and bioresins. The second polymer selected for the molding process should generally have a lower melting temperature than the first polymer.

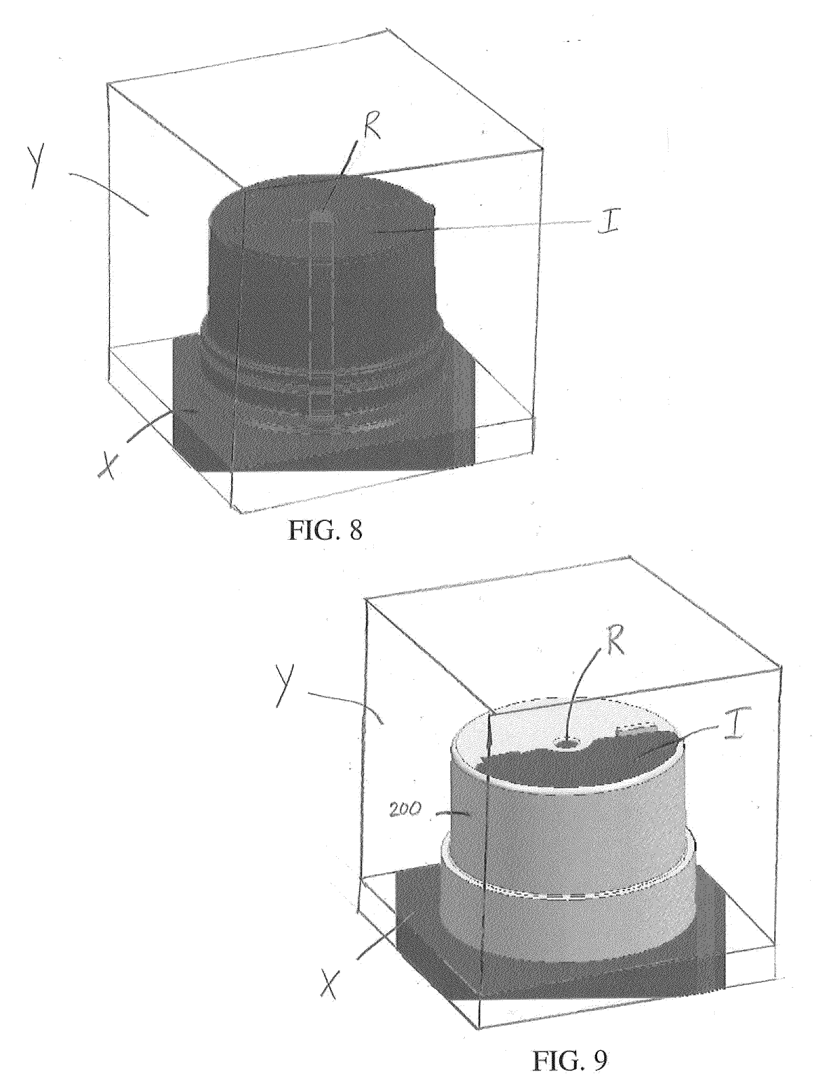

The molding process 700 utilizes a molding station, which includes mold details X, Y, and Z. To being the molding process mold details X and Y are closed upon each other, as illustrated in FIG. 8 (block 704). When closed together, mold details X and Y form a cavity, which determines the shape of the base 200. Next, as illustrated in FIG. 9, molten polymer of the first type is injected into mold details X and Y to form the base (block 708). It should be noted that, mold details X and Y contact each other at the portions of the molds labeled I, thus molten polymer does not flow between the molds X, Y at portion I during the injection process. The void introduced by the contact of molds X and Y at portion I forms the base opening 220.

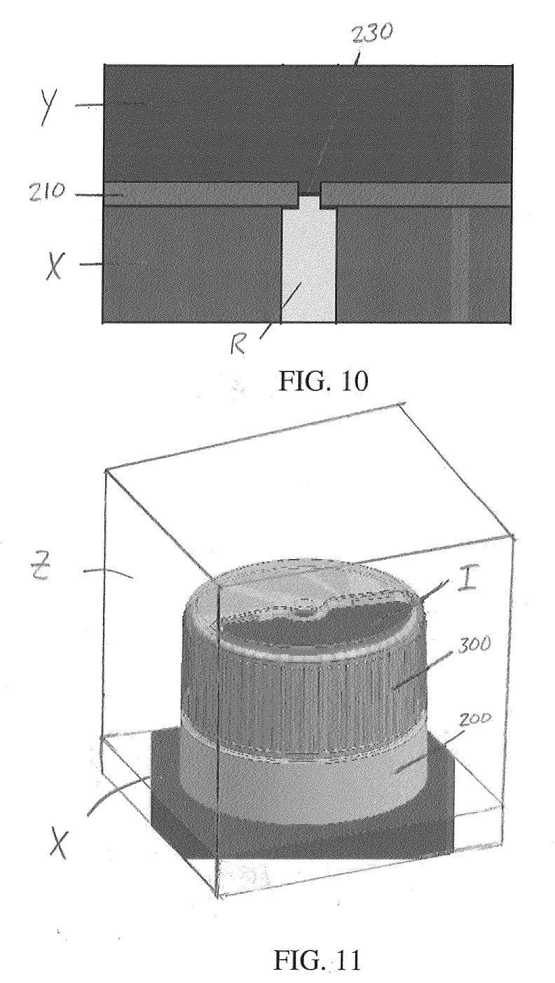

Mold detail X includes a retractable pin, such as rod R utilized to form the rotational aperture 230. As shown in FIG. 10, a portion of the rod R the same diameter as the rotational aperture 230 extends above the upper surface of mold detail X and contacts a similarly sized portion of mold detail Y. As polymer of the first type is injected into mold details X and Y, molten polymer surrounds the tip of rod R. When the polymer of the first type cools, rod R is retracted into mold detail X (block 712). Retraction of the rod R creates a second void in the injected first polymer that forms the rotational aperture 230, as visible in FIG. 9.

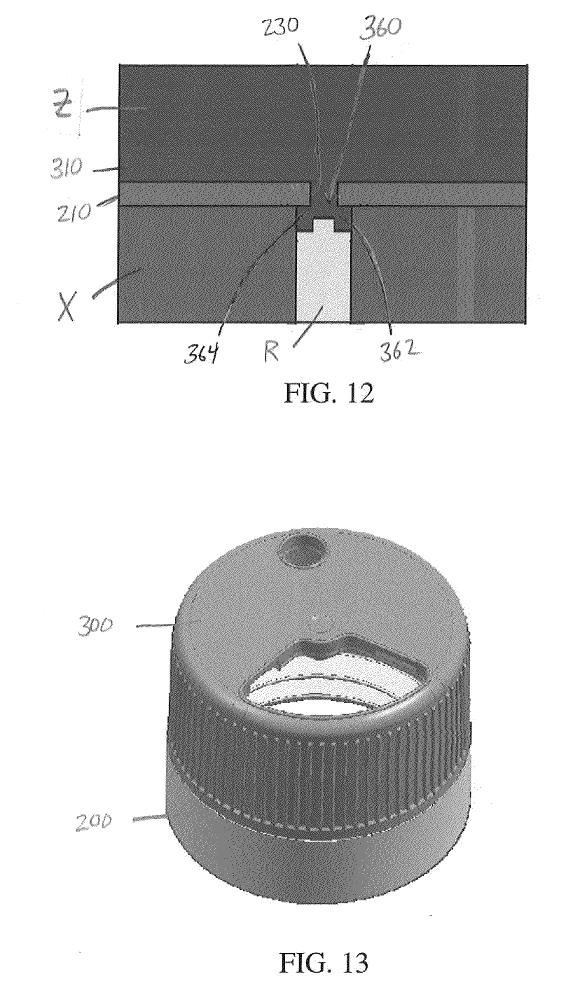

After the rod R is retracted, mold detail Y is removed from mold detail X (block 716). Next, with molten polymer of the first type still surrounding the outer surface of mold detail X, mold detail Z is joined to mold detail X, as illustrated in FIG. 11 (block 720). Subsequently, molten polymer of the second type is injected into the cavity formed by mold details X and Z to form the cap (block 724). Thus, as the polymer of the second type is injected between mold details X and Z, portions of the molten second polymer directly contact the first polymer. Accordingly, the interior surface of the cap 300 is substantially the same shape as the exterior of the base 200, because the exterior surface of the base 200, in conjunction with the interior surface of mold detail Z, defined the cavity into which the second polymer was injected. Furthermore, molten polymer of the second type flows into the rotational aperture 230, thereby filling the aperture 230 and creating the protrusion 360, which secures the cap 300 to the base 200, as illustrated in FIG. 12. Finally, note that mold detail Z also includes a region I, which contacts and is aligned with the area of mold detail X labeled I. Because the mold details X, Z contact each other, molten polymer of the second type does not flow into portion I of the mold details X, Z, thereby forming the cap opening 320. When the second polymer as sufficiently cooled, mold detail Z is removed from mold detail X and the closure 100 is ejected from mold detail X (block 728).

As the material used to form the cap 300 cools, it tends to shrink; however, the exterior surface of the base 200 restricts the interior surface of the cap 300 from shrinking. Therefore, the interior surface of the cap 300 imparts a compressive force upon the base 200 resulting in a zero clearance fit between the cap 300 and the base 200. Thus, in the completed product, when the closure 100 is in the closed position, the disk region 210 of the base 200 tightly fills the cap opening 320, thereby creating a seal between the cap 300 and the base 200 impervious to liquids of both high and low viscosity. Furthermore, because of the compressive force of the cap 300, the base 200 should be formed of a material that does not shatter or crack under compressive stress, such as a polymer material that flexes or bends to conform to the final size of the cap 300. In addition, note that the exterior surface of the cap 300 may shrink slightly as the material of the cap 300 cools.

In operation, the closure 100 may be coupled to a connecting region of a container C, often referred to as the neck of the container C. Specifically, the connecting structure 260 may be threaded upon a container C neck to form a liquid tight seal between the container C neck and the base 200. To dispense the contents of a container C, the closure 100 may be oriented in the open configuration by grasping and rotating the cap 300. Initially, the resistance of the stop detent 240 seated in the detent groove 330 may impede the rotational force; however, with a continued force the polymer base 200 material flexes and the stop detent 240 “snaps” out of the detent groove 330, permitting the cap 300 to rotate smoothly to the open configuration.

As the cap 300 is rotated to the fully open configuration the base opening 220 and the cap opening 320 align and the stop detent 240 becomes seated in detent groove 335. In the open configuration a liquid, semi-liquid, solid, powdered, or granular product may be dispensed from the container C through the openings 210, 310 in the closure 100.

To seal a product within a container C, the closure 100 may be rotated to the closed configuration. As the cap 300 nears the closed configuration, the zero-clearance fit between the base 200 and cap 300 generates a shear action that clears excess product from the sealing surfaces, thereby preventing dried product residue from fouling the integrity of the seal between the cap 300 and base 200. To ensure the closure 100 is completely closed, the cap 300 should be rotated until the stop detent 240 enters detent groove 330.

As illustrated in FIG. 13, another embodiment of the closure 100 may include a cap 300 having a first opening that encompasses one-third of the disk region 310 and a second opening having a circular periphery. The closure 100 may be opened and closed by rotating the cap 300 one-third of a complete turn.

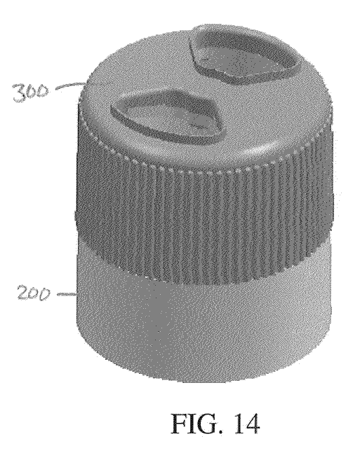

Furthermore, as illustrated in FIG. 14, another embodiment of the closure 100 may include a cap 300 having two openings that each encompass one-fourth of the disk region 310. The closure 100 may be opened and closed by rotating the cap 300 one-fourth of a complete turn.

Although a container closure 100 has been described with respect to certain preferred embodiments, it will be appreciated by those of skill in the art that other utensil implementations and adaptations are possible. Moreover, there are advantages to individual advancements described herein that may be obtained without incorporating other aspects described above. Therefore, the spirit and scope of the appended claims should not be limited to the description of the preferred embodiments contained herein, and the claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants, patentees, and others.

What is claimed is:

1. A closure for a container comprising:
a base comprising a first material; and
a cap comprising a second material, the cap movably connected to the base.

2. The closure of claim 1 further comprising:
a first opening in the base;
a sealing region of the cap; and
a second opening in the cap, the cap configured to rotate about the base to permit the second opening to align with the first opening, the cap further configured to rotate about the base to permit the sealing region to align with the first opening.

3. The closure of claim 2 further comprising:
a detent extending from the base;
a first recess in the cap configured to accept the detent when the second opening is aligned with the first opening; and
a second recess in the cap configured to accept the detent when the sealing region is aligned with the first opening.

4. The closure of claim 1 further comprising:
an aperture in the base; and
a protrusion extending from the cap, the protrusion configured to nonremovably and rotatably secure the cap to the base.

5. The closure of claim 1, wherein the base further comprises:
a first connecting region configured to secure the base to a corresponding second connecting region of a container.

6. The closure of claim 1, wherein the cap further comprises a first disk region and a first sidewall region, the first disk region having a first opening, and wherein the base further comprises a second disk region and a second sidewall region, the second disk region having a second opening and a solid portion.

7. The closure of claim 6, wherein the cap is rotatable between an open position in which the first opening is aligned with the second opening, and a closed position in which the first opening is aligned with the solid portion, the solid portion having a larger area than the first opening to form overlap region between the first opening and the solid region.

8. The closure of claim 6 further comprising:
a plurality of ridges and grooves upon the exterior of the first sidewall region, the ridges and grooves creating a surface sufficient for gripping.

9. The closure of claim 1 wherein the first material is chemically incompatible with the second material such that the first material does not bond to the second material during or after a molding process.

10. A method of making a closure comprising:
molding a base comprising a first material within a multi-component mold;
removing at least one component of the multi-component mold and leaving the molded base within at least one remaining component of the multi-component mold; and
molding a cap comprising a second material using the at least one remaining component of the multi-component mold.

11. The method of making a closure of claim 10, wherein molding a base comprising a first material within a multi-component mold further comprises:
injecting the first material around a retractable pin.

12. The method of making a closure of claim 11, wherein removing at least one component of the multi-component mold and leaving the molded base within at least one remaining component of the multi-component mold further comprises:
retracting the retractable pin to form an opening in the base.

13. The method of making a closure of claim 12, wherein molding a cap comprising a second material using the at least one remaining component of the multi-component mold further comprises:
injecting the second material through the opening in the molded base formed by the retractable pin.

14. The method of making a closure of claim 10, wherein the first material and the second material are injection moldable thermoplastic polymers.

15. The method of making a closure of claim 10, wherein the first material is chemically incompatible with the second material such that the first material does not chemically bond to the second material.

16. The method of making a closure of claim 15, wherein the first material is an injection moldable thermoplastic polymer selected from the group consisting of polyethylene, polypropylene, polyester, and bioresin.

17. The method making a closure of claim 15, wherein the second material is an injection moldable thermoplastic polymer selected from the group consisting of polyethylene, polypropylene, polyester, and bioresin.

18. The method of making a closure of claim 15, wherein the second material decreases in size subsequent to the molding process.

19. The method of making a closure of claim 11, wherein molding the base and molding the cap further comprises:
using the first material and the second material in a sequential injection molding process.

20. A container closure comprising:
a base comprising a first material; and
a cap comprising a second material, the cap moveably connected to the base, wherein the base and the cap are formed by a multi-shot sequential injection molding process.
